(19) United States
(12) Patent Application Publication
(10) Pub. No.: US 2023/0085026 A1
(43) Pub. Date: Mar. 16, 2023

(54) LOCK ASSEMBLIES FOR A CONTAINER

(71) Applicant: Rehrig Pacific Company, Los Angeles, CA (US)

(72) Inventor: Derick Harold Foster, Cumming, GA (US)

(21) Appl. No.: 17/879,203

(22) Filed: Aug. 2, 2022

Related U.S. Application Data
(60) Provisional application No. 63/243,466, filed on Sep. 13, 2021.

(51) Int. Cl. B65F 1/16; B65F 1/02

(52) U.S. Cl. CPC B65F 1/1615; B65F 1/02; B65F 2210/165; B65F 2210/128

(57) ABSTRACT

A cart includes a body portion that forms a receptacle. A lid is pivotable relative to the body portion. A lock assembly includes a pair of hasps attached to the lid. A lock is attached to the receptacle that has a pair of hasp receptacles located on a body portion of the lock with the pair of hasp receptacles being mechanically connected to at least one actuator.

### CROSS-REFERENCE TO RELATED APPLICATIONS

This application claims priority to U.S. Provisional Application No. 63/243,466 which was filed on Sep. 13, 2021 and is incorporated herein by reference.

### BACKGROUND

The present disclosure relates to a container and, more particularly, to a lock for a lid on the container.

Containers, such as roll-out carts, are commonly used by municipalities for collecting debris from households or businesses. The containers are movable by tipping and balancing the container on a pair of wheels adjacent a rear side of the base of the container. It is common for these containers to contain food waste that may attract animals in the area that could open the container and spread the waste. The lid on the container can prevent many animals from accessing the food waste. However, in the case of larger animals, such as with bears, additional steps, such as the use of a lock, may need to be taken to prevent the animal from accessing the waste in the container.

### SUMMARY

In one exemplary embodiment, a cart includes a body portion that forms a receptacle. A lid is pivotable relative to the body portion. A lock assembly includes a pair of hasps attached to the lid. A lock is attached to the receptacle that has a pair of hasp receptacles located on a body portion of the lock with the pair of hasp receptacles being mechanically connected to at least one actuator.

In another embodiment according to any of the previous embodiments, the at least one actuator is in electrical communication with a controller configured to direct the pair of hasp receptacles between a locked position and an unlocked position in response to receiving a signal from a remote location.

In another embodiment according to any of the previous embodiments, the at least one actuator is gravity actuated and configured to direct the pair of hasp receptacles between a locked position when the cart is in a first position and an unlocked position when the cart is in a non-upright orientation.

In another embodiment according to any of the previous embodiments, the lock is located on an interior side of the receptacle opposite a handle on the body portion of the receptacle. The pair of hasp receptacles each include a catch pivotable about a separate pivot axis.

In another embodiment according to any of the previous embodiments, the lock includes a pair of hasp receptacles located in a common lock housing with the at least one actuator.

In another embodiment according to any of the previous embodiments, the lock includes a pair of opposing latch release buttons located in recesses of a body portion of the lock.

In another embodiment according to any of the previous embodiments, the pair of latch release buttons are located on a central body portion of the lock. The each of the pair of latches hasp receptacles are mechanically connected to central body portion of the lock by an actuator cable.

In another embodiment according to any of the previous embodiments, the central body portion of the lock and the pair of latches hasp receptacles are located on an exterior side of the body portion forming the receptacle.

In another exemplary embodiment, a cart includes a body portion forming a receptacle. A lid is pivotable relative to the body portion. A lock assembly includes a claw moveably attached to the lid and includes at least one hook. A lock is configured to secure the claw in a locked position relative to the lid.

In another embodiment according to any of the previous embodiments, the claw is moveable in a channel located between an unlocked position and the locked position.

In another embodiment according to any of the previous embodiments, the channel includes an aft retention lip for accepting the claw in the locked position and a forward retention lip of accepting the claw in the unlocked position.

In another embodiment according to any of the previous embodiments, the at least one hook surrounds a lip on the body portion.

In another embodiment according to any of the previous embodiments, the claw includes a central leg that is retractable into the lock.

In another embodiment according to any of the previous embodiments, the at least one hook includes a side hook on each of a pair of side protrusions extending from the central leg. A central hook on a central protrusion extends from the central leg.

In another embodiment according to any of the previous embodiments, the lock includes a pair of opposing latch release buttons located in recesses of a body portion of the lock.

In another exemplary embodiment, a cart includes a body portion that forms a receptacle. A lid is pivotable relative to the body portion. A lock assembly includes a retractable belt fixed to the body portion. A lock is configured to accept a hasp on the retractable belt.

In another embodiment according to any of the previous embodiments, the lock includes an actuator configured to move the lock between a locked position and an unlocked position. The lock includes a pair of opposing latch release buttons located in recesses of a body portion of the lock.

In another embodiment according to any of the previous embodiments, the actuator is gravity actuated to secure the hasp relative to the lock when the cart is in a first position and to release the hasp from the lock when the cart is in a non-upright orientation.

In another embodiment according to any of the previous embodiments, the actuator is in electrical communication with a controller configured to directed the actuator between a locked position and a released position in response to a receive a signal from a remote location.

In another embodiment according to any of the previous embodiments, the belt housing is attached to the body portion on a first side of the body portion and the lock is located on a second opposite side of the body portion. The lid includes a belt channel that extends from opposing sides of the lid and is aligned with the belt housing and the lock.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example roll-out cart.

FIG. 2 illustrates an example lock assembly for use with the roll-out cart of FIG. 1.

FIG. 3 illustrates an interior perspective view of the roll-out cart of FIG. 1.

FIG. 4 illustrates another example roll-out cart.

FIG. 5 illustrates an example lock assembly for the roll out cart of FIG. 4.

FIG. 6 illustrates the example lock assembly of FIG. 5 in an unlocked or extended position.

FIG. 7 illustrates the roll-out cart of FIG. 4 with a lid in an open position.

FIG. 8 illustrates yet another roll-out cart.

FIG. 9 illustrates a lock assembly for the roll-out cart of FIG. 8.

FIG. 10 illustrates the roll-out cart of FIG. 8 with a lid in an open position.

FIG. 11 illustrates an interior perspective view of the lid on the roll-out cart of FIG. 8.

FIG. 12 illustrates a further example roll-out cart.

FIG. 13 illustrates an example lock assembly for the roll-out cart of FIG. 12.

FIG. 14 illustrates a perspective view of the lock assembly of FIG. 13 in an unlocked position.

FIG. 15 illustrates another perspective view of the lock assembly of FIG. 13 in an unlocked position.

### DETAILED DESCRIPTION

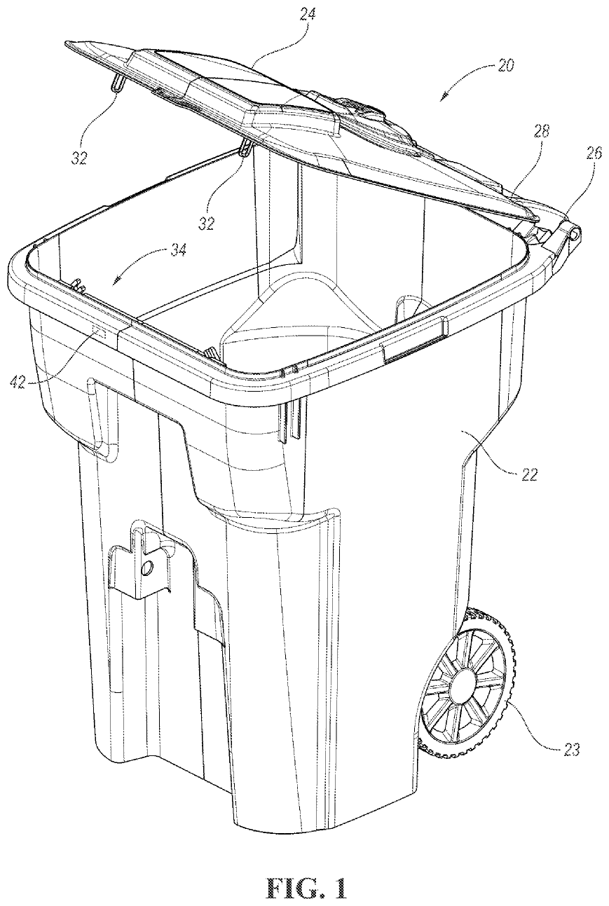

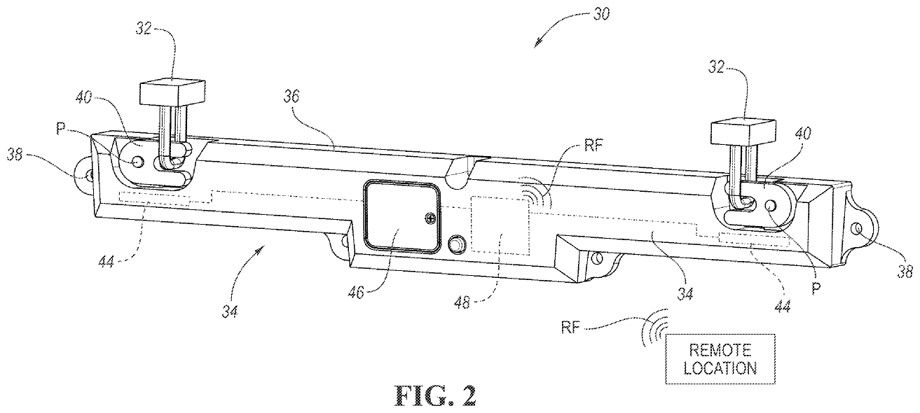

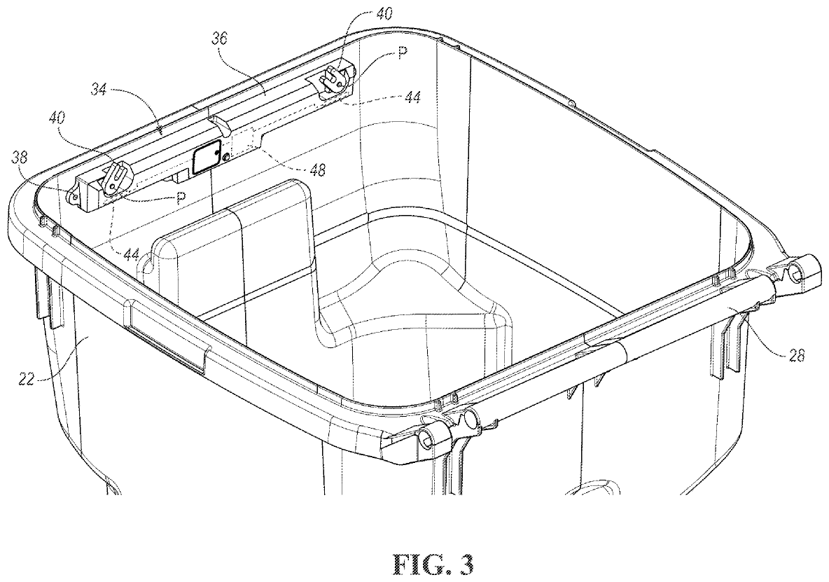

FIGS. 1-3 illustrate an example roll-out cart 20. The roll-out cart 20 includes a body portion 22 forming a receptacle for receiving materials, such as debris or household waste. Because the cart 20 can store household waste, which can include food scraps, the cart 20 can attract animals when stored outside or left by the roadside for pick up. To prevent access into the cart 20, the cart 20 includes a lid 24 that is pivotably attached a hinge 26. The cart 20 also includes a handle 28 fixed to the body portion 22 that incorporates the hinge 26 and allows a user to maneuver the cart 20. A lock assembly 30 allows for selective access into a receptacle formed by the body portion 22 of the cart 20. In the illustrated example, the lock assembly 30 includes a pair of hasps 32 fixed relative to the lid 24 and a lock 34 fixed relative to the body portion 22 for receiving the hasps 32 to prevent the lid 24 from pivoting about the hinge 26.

One feature of having the pair of hasps 32 securing the lid 24 to the body portion 22 is improved durability. In particular, the lid 24 is secured to the body portion 22 along the side with the hinge 26 as well as two locations along an opposite side of the body portion 22 from the hinge 26. Also, having the pair of hasps 32 reduces an amount that the lid 24 can be pried open from flexing the lid 24 while the hasps 32 are in a locked position.

As shown in FIGS. 1-3, the lock 34 includes an elongated body portion having a pair of catches 40, or hasp receptacles, located adjacent opposing ends of the body portion 36 of the lock 34. One feature of the separation of the pair of catches 40 is improved rigidity of the lid 24 when locked as discussed above. The body portion 36 also includes a pair of fastener openings 38 located at opposing ends to secure the lock 34 to an interior surface of the body portion 22 of the cart 20. The catches 40 are each pivotable about a pivot axis P that is transverse or perpendicular to a sidewall of the body portion.

In the illustrated example, the lock 34 includes a pair of actuators 44 in electrical communication with a power source 46 and a controller 48. Each of the actuators 44 is located adjacent a corresponding one the catches 40. However, a single one of the actuators 44 could be mechanically connected to each of the catches 40 to cause the catches 40 to release. The controller 48 includes a microprocessor, memory, and a transmitter/receiver to communicate with a remote location R, such as a garbage collection vehicle, over a radio frequency (“RF”) to release the hasps 32 from each of a corresponding one of the catches 40.

Furthermore, each of the pair of actuators 44 could be gravity actuated such that the catches 40 remain in a locked position when the cart 20 is in an upright position and the catches move into an unlocked or released position when the cart 20 has tilted beyond a predetermined threshold. For example, the catches 40 would not move to a released or unlocked position until the cart 20 is at least partially inverted to simulate dumping by a garbage truck. Also, the catches 40 could remain locked when in a horizontal position, such as when tipped on its side by an animal trying to access the interior of the cart 20. Alternatively, a manual release 42 could be located on an exterior side of the body portion 22 adjacent the lock 34 to allow the lock 34 to be manually released.

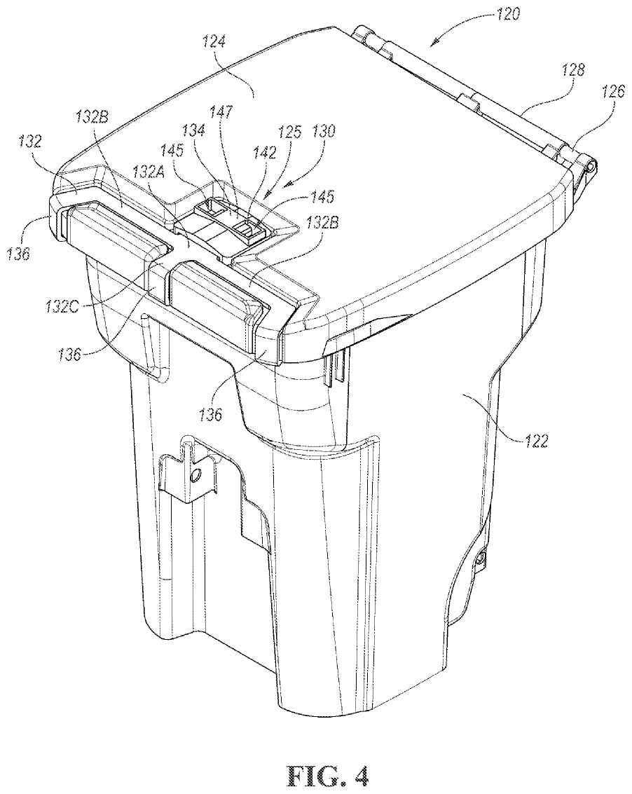

FIGS. 4-7 illustrate another example roll-out cart 120. The roll-out cart 120 is similar to the cart 20 except where described below or shown in the Figures. Similar numbers are used between the cart 120 and the cart 20 with the addition of a leading 1. The roll-out cart 120 includes a body portion 122 forming a receptacle and a lid 124 that pivots about a hinge 126 to provide access into the cart 120. The cart 120 also includes a handle 128 fixed to the body portion 122 that incorporates the hinge 126 and allows a user to maneuver the cart 120.

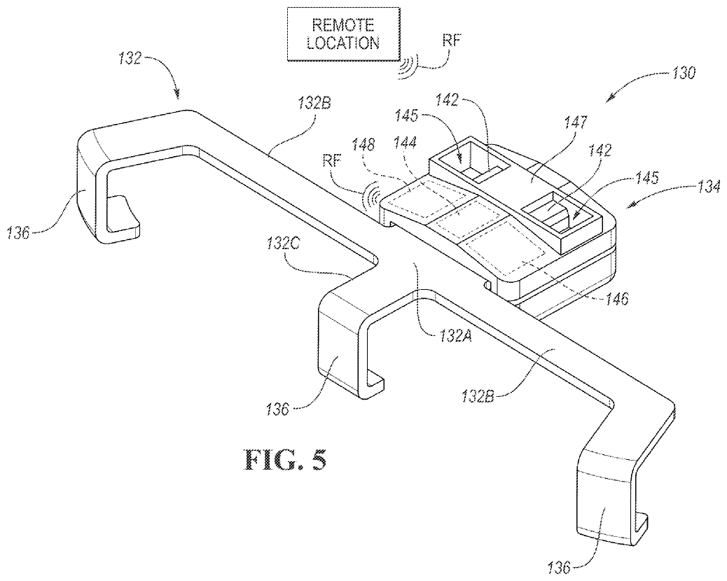

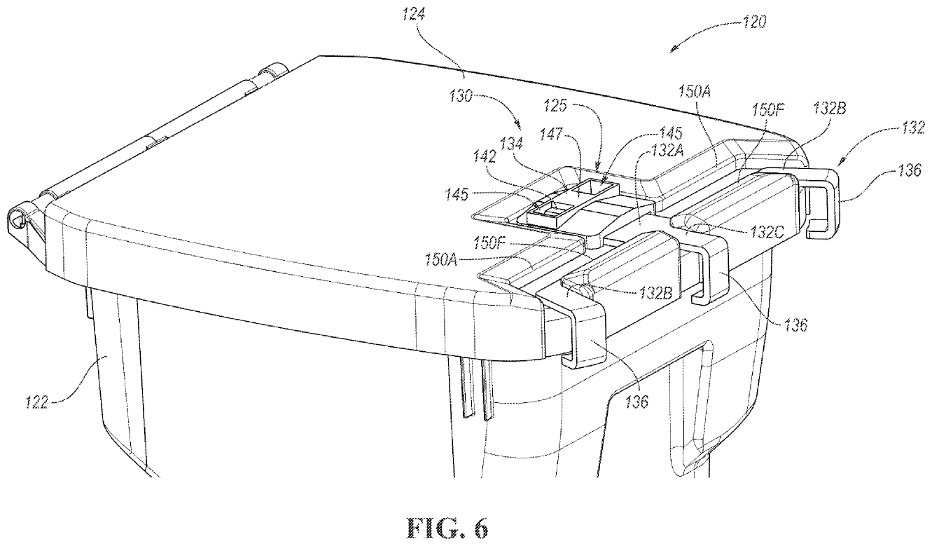

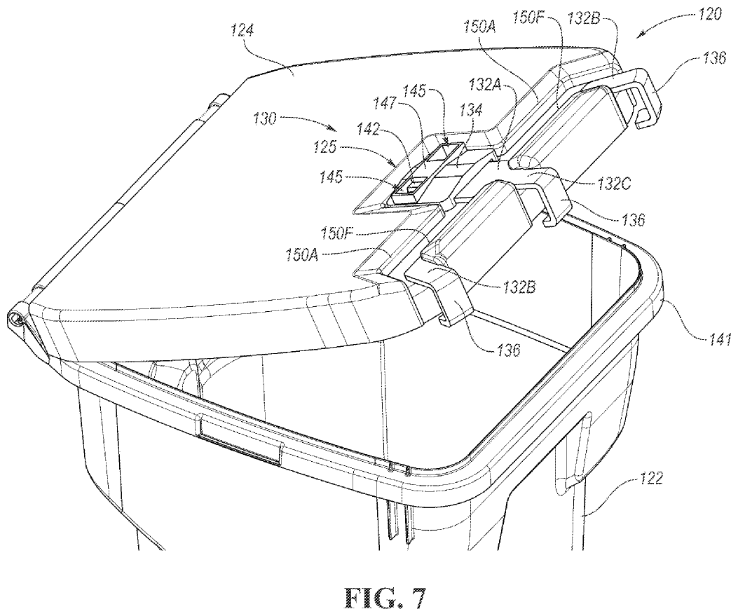

A lock assembly 130 includes a claw 132, or a catch, and a lock 134 both located on the lid 124 for selectively allowing the lid 124 to pivot on the hinge 126 to provide access into the cart 120. In the illustrated example, the lock assembly 130 is located on an exterior side of the lid 124. The claw 132 is selectively moveable relative to the lock 134 between an extended or unlocated position as shown in FIGS. 6 and 7 or a retracted or locked position as shown in FIGS. 4 and 5.

In the illustrated example, the claw 132 includes a central leg 132A that is moveable into and out of the lock 134, a pair of side protrusions 132B that extend laterally from the central leg 132A, and a central protrusion 132C that extends from a midportion of the central leg 132A. Each of the side protrusions 132B and the central protrusion 132C include a hook 136 at a distal end forming a recessed channel.

The hooks 136 extend around a perimeter of the lid 124 and around a lip 141 (FIG. 7) on the body portion 122 to fix the lid 124 to the body portion 122. When the claw 132 is moved to a retracted or locked position (FIGS. 4 and 7), the hooks 136 extend around the lid 124 and under the lip 141 on the body portion 122 to prevent the lid 124 from pivoting on the hinge 126. One feature of having the claw 132 with the hooks 136 is to provide improved durability of the lid 124 by having multiple latching points between the lid 124 and the body portion 122.

The claw 132 and lock 134 are located in a recessed portion 125 or channel on the lid 124 to prevent the claw 132 and lock 134 from protruding above an upper surface of the lid 124. One feature of this configuration is to allow other objects to be stacked on top of the lid 124 without impeding movement of the claw 132 or making objects stacked thereon unstable.

Additionally, the recessed portion 125 includes a forward retention lip 150F that partially surrounds a forward edge of the claw 132 when in an extended position and an aft retention lip 150A that partially surrounds an opposing or aft edge of the claw 132 when the claw 132 is in the retracted position. The forward and aft retention lips 150F, 150A prevent the claw 132 from being pried from the recessed portion 125 to grant unauthorized access into the cart 120.

To selectively grant or prevent movement of the claw 132, the lock 134 includes a pair of opposing latch release buttons 142 in corresponding recesses 145 in a body portion 147 of the lock 134. The claw 132 can be released from the lock 134 by depressing the buttons 142 simultaneously or individually depending on a desired level of security. Additionally, the claw 132 can be spring loaded into the lock 134 to cause the claw 132 to spring to an extended position when released. This spring movement also provides confirmation to a user that the buttons 142 have been sufficiently activated to release the claw 132. One additional feature of having the buttons 142 located in the recesses 145 is improved tamper resistance from animals. Also, the inward pinching motion required to actuate the buttons 142 makes it more difficult for smaller animals to engage the buttons 142 and the recesses 145 makes it harder for larger animals to reach.

In the illustrated example, the lock 134 includes at least one actuator 144 in electrical communication with a power source 146 and a controller 148 having a microprocessor, memory, and a transmitter/receiver to communicate with a remote location, such as a garbage collection vehicle, over a radio frequency to release the claw 132. Furthermore, the actuator 144 could be gravity actuated such that the lock 134 remains in a locked position when the cart 120 is in an upright position and in an unlocked or released position when the cart 120 has tilted beyond a predetermined threshold as described above.

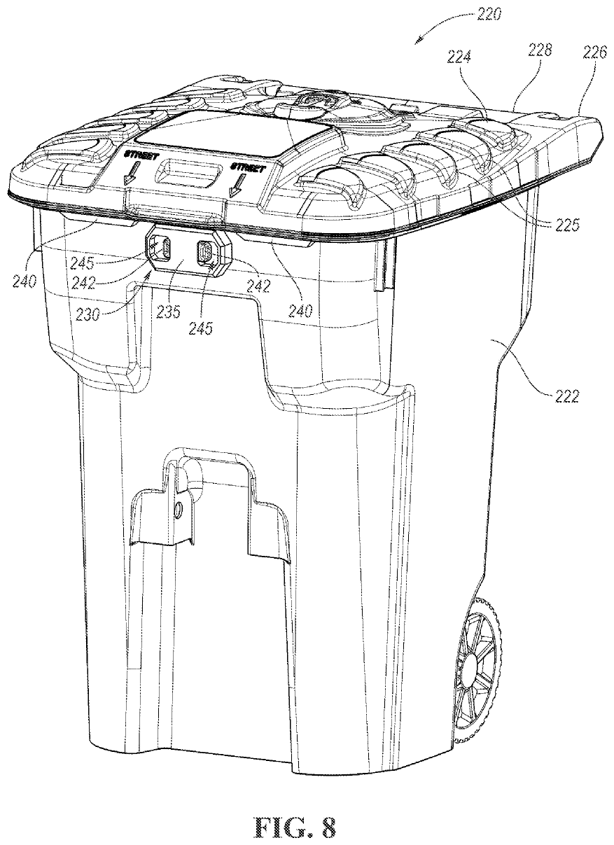

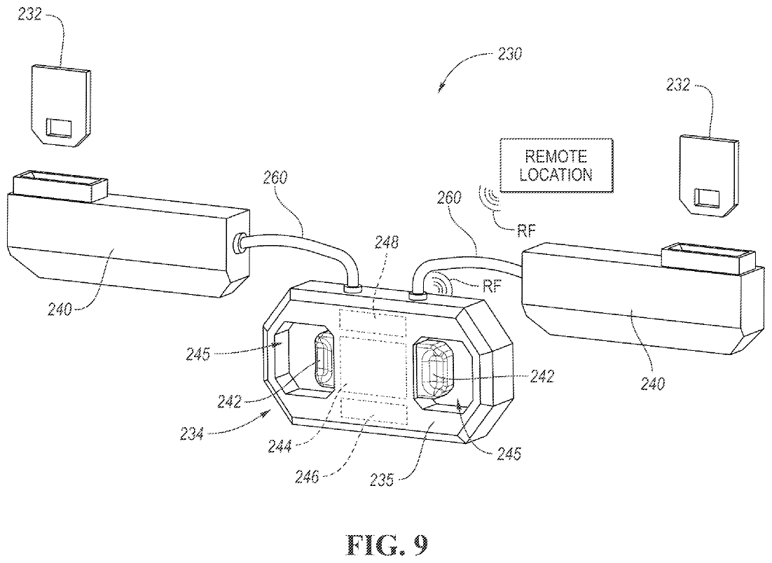

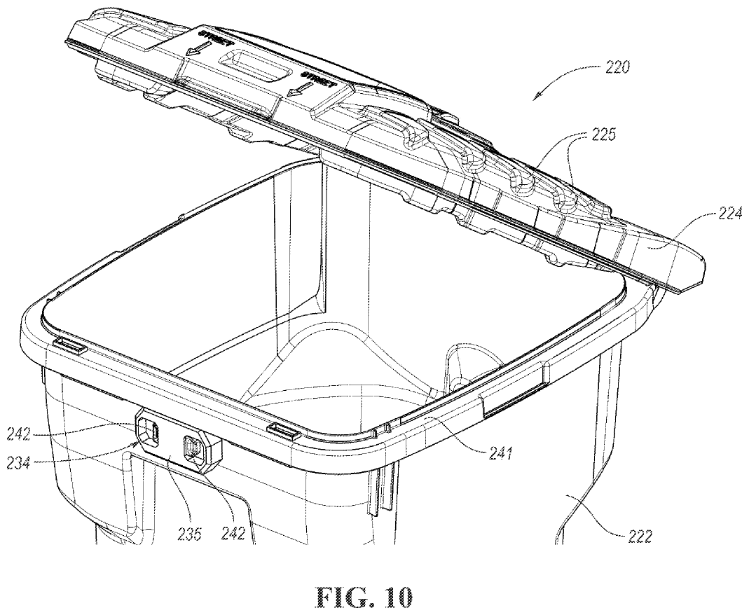

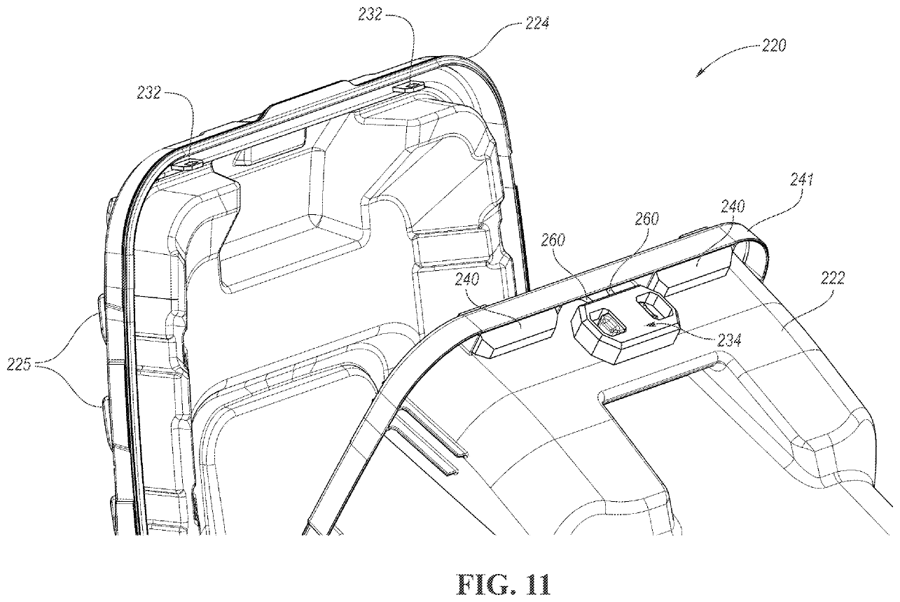

FIGS. 8-11 illustrate another example roll-out cart 220. The roll-out cart 220 is similar to the cart 20 except where described below or shown in the Figures. Similar numbers will be used between the cart 120 and the cart 20 with the addition of a leading 2. The roll-out cart 220 includes a body portion 222 forming a receptacle and a lid 224 that pivots about a hinge 226 to provide access into the cart 220. The cart 220 also includes a handle 228 fixed to the body portion 222 that incorporates the hinge 226 and allows a user to maneuver the cart 220.

A lock assembly 230 allows for selective access into the cart 220. The lock assembly 230 includes a pair of hasps 232 fixed relative to the lid 224 and a lock 234 fixed relative to the body portion 222 for receiving the hasps 232 to prevent the lid 224 from pivoting about the hinge 226. In the illustrated example, the hasps 232 are buckle styled as opposed to loop styled with the hasps 32. One feature of having the pair of hasps 232 securing the lid 224 to the body portion 222 is improved durability by securing the lid 224 to the body portion 222 along the hinge 226 as well as at two locations along an opposite side of the body portion 222 from the hinge 226. Also, having the pair of hasps 232 reduces an amount that the lid 224 can be pried open from flexing the lid 224 while the hasps 232 are still in a locked position. Furthermore, the lid 224 includes a plurality of ribs 225 that increase the rigidity of the lid 224 to prevent it from deforming.

As shown in FIGS. 8-11, the lock 234 includes a central body portion 235 having a pair of latches 240 or catches spaced from the central body portion 235 and aligned to receive the hasps 232 on the lid 224. The central body portion 235 also includes a pair of release buttons 242 located in corresponding recesses 245 to selectively release a corresponding one of the hasps 232 from one of the latches 240. Each of the buttons 242 are connected to the latches 240 through a mechanical linkage 260, such as an actuator cable. The central body portion 235 and the latches 240 are located on an exterior side of the body portion 222 with the latches 240 positioned in a recessed area formed by a lip 241 in the body portion 222. The lip 241 includes openings to allow the hasps 232 to pass through the lip 241 and reach the latches 240. The lip 241 also provides protection for the pair of latches 240.

In the illustrated example, the lock 234 includes at least one actuator 244 in electrical communication with a power source 246 and a controller 248 having a microprocessor, memory, and a transmitter/receiver to communicate with a remote location, such as a garbage collection vehicle, over a radio frequency to release the hasps 232 from the latches 240. Furthermore, the actuator 244 could be gravity actuated such that the latches 240 remain in a locked position when the cart 220 is in an upright position and in an unlocked or released position when the cart 220 has tilted beyond a predetermined threshold as described above.

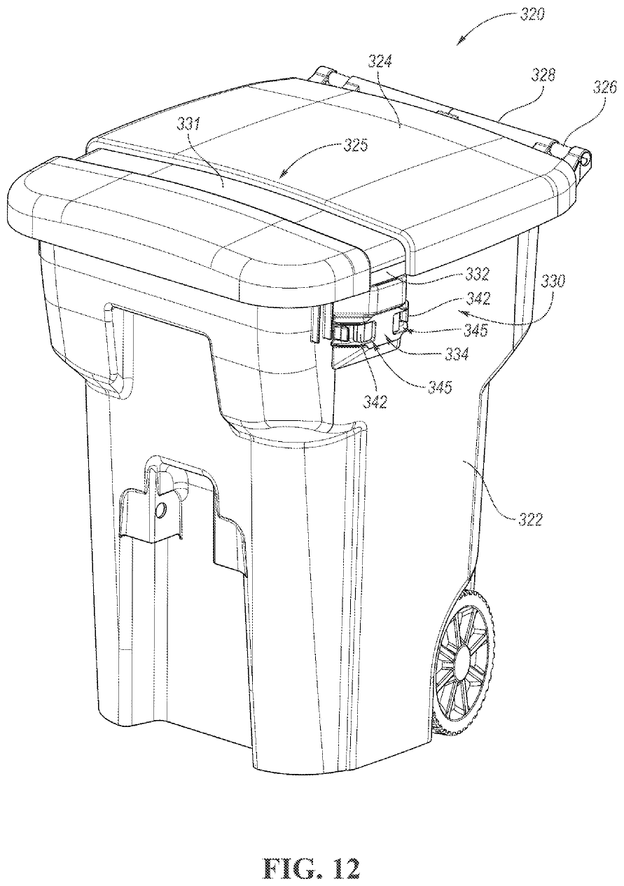

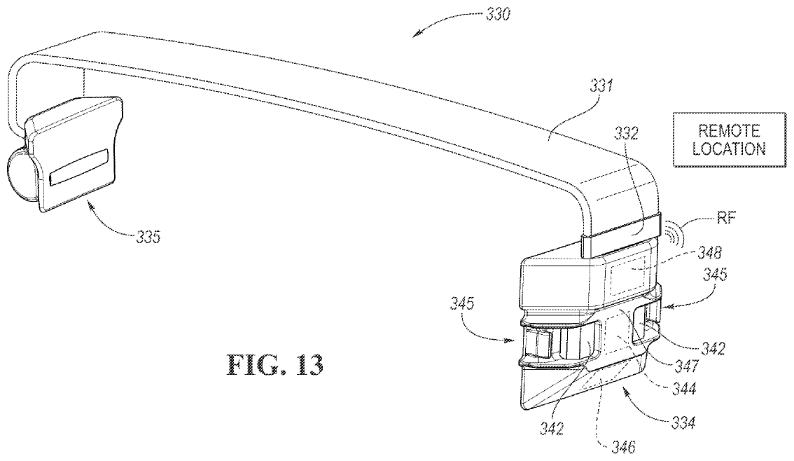

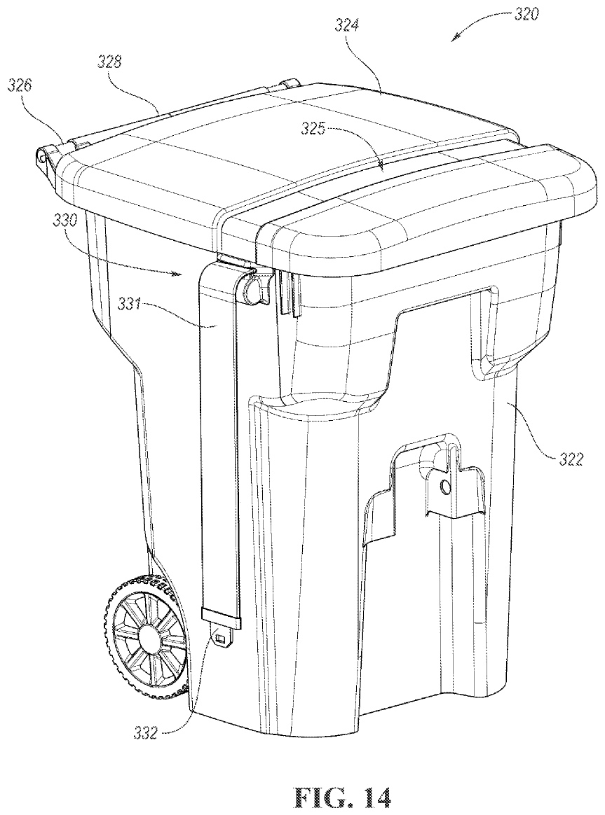

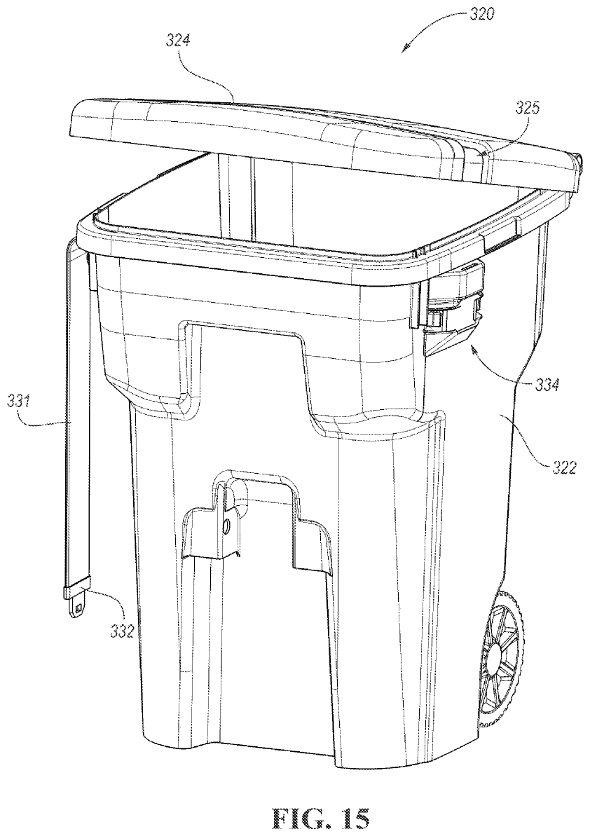

FIGS. 12-15 illustrate another example roll-out cart 320. The roll-out cart 320 is similar to the cart 20 except where described below or shown in the Figures. Similar numbers will be used between the cart 320 and the cart 20 with the addition of a leading 3. The roll-out cart 320 includes a body portion 322 forming a receptacle and a lid 324 that pivots about a hinge 326 to provide access into the cart 320. The cart 320 also includes a handle 328 fixed to the body portion 322 that incorporates the hinge 326 and allows a user to maneuver the cart 320.

The locking assembly 330 includes a retractable belt 331 having a hasp 332 at the distal end with a buckle style. The retractable belt 331 can be retracted into a belt housing 335 located on a first lateral side of the body portion 322. A lock 334 is located on an opposite lateral side of the body portion 322 from the belt housing 335 to selectively release the hasp 332 and allow the lid 324 to pivot on the hinge 326 to provide access into the cart 320.

When the hasp 332 on the retractable belt 331 is located in the lock 334, the belt 331 is located in a recessed portion 325 or channel on the lid 324 to prevent the belt 331 from protruding above an upper surface of the lid 324 or sliding off of the lid 324. One feature of this configuration is to allow other objects to be stacked on top of the lid 324 without impeding movement of the belt 331.

To selectively grant or prevent movement of the belt 331, the lock 334 includes a pair of opposing latch release buttons 342 in corresponding recesses 145 in a body portion 347 of the lock 334. The hasp 332 can be released from the lock 334 by depressing the buttons 342 simultaneously or individually depending on a desired level of security. Additionally, the hasp 332 can be spring loaded into the lock 334 to cause it to move out of the lock 334 when released. This movement also provides confirmation to a user that the buttons 342 have been sufficiently activated to release hasp 332. One additional feature of having the buttons 342 located in the recesses 345, is improved tamper resistance from animals, such as bears. Also, the inward pinching motion required to actuate the buttons 342 makes it more difficult for smaller animals to engage the buttons 342.

In the illustrated example, the lock 334 includes at least one actuator in electrical communication with a power source 346 and a controller 348 having a microprocessor, memory, and a transmitter/receiver to communicate with a remote location, such as a garbage collection vehicle, over a radio frequency to release the hasp 332. Furthermore, the actuator 344 could be gravity actuated such that the lock 334 remain in a locked position when the cart 320 is in an upright position and in an unlocked or released position when the cart 320 has tilted beyond a predetermined threshold as described above.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A cart comprising:
a body portion forming a receptacle;
a lid pivotable relative to the body portion; and
a lock assembly including:
a pair of hasps attached to the lid; and
a lock attached to the receptacle having a pair of hasp receptacles located on a body portion of the lock with the pair of hasp receptacles being mechanically connected to at least one actuator.

2. The cart of claim 1, wherein the at least one actuator is in electrical communication with a controller configured to direct the pair of hasp receptacles between a locked position and an unlocked position in response to receiving a signal from a remote location.

3. The cart of claim 1, wherein the at least one actuator is gravity actuated and configured to direct the pair of hasp receptacles between a locked position when the cart is in a first position and an unlocked position when the cart is in a non-upright orientation.

4. The cart of claim 1, wherein the lock is located on an interior side of the receptacle opposite a handle on the body portion of the receptacle and the pair of hasp receptacles each include a catch pivotable about a separate pivot axis.

5. The cart of claim 4, wherein the lock includes a pair of hasp receptacles located in a common lock housing with the at least one actuator.

6. The cart of claim 1, wherein the lock includes a pair of opposing latch release buttons located in recesses of a body portion of the lock.

7. The cart of claim 6, wherein the pair of latch release buttons are located on a central body portion of the lock and the each of the pair of latches hasp receptacles are mechanically connected to central body portion of the lock by an actuator cable.

8. The cart of claim 7, wherein the central body portion of the lock and the pair of latches hasp receptacles are located on an exterior side of the body portion forming the receptacle.

9. A cart comprising:
a body portion forming a receptacle;
a lid pivotable relative to the body portion; and
a lock assembly including:
a claw moveably attached to the lid and including at least one hook; and
a lock configured to secure the claw in a locked position relative to the lid.

10. The cart of claim 9, wherein the claw is moveable in a channel located between an unlocked position and the locked position.

11. The cart of claim 10, wherein the channel includes an aft retention lip for accepting the claw in the locked position and a forward retention lip of accepting the claw in the unlocked position.

12. The cart of claim 10, wherein the at least one hook surrounds a lip on the body portion.

13. The cart of claim 12, wherein the claw includes a central leg that is retractable into the lock.

14. The cart of claim 13, wherein the at least one hook includes a side hook on each of a pair of side protrusions extending from the central leg and a central hook on a central protrusion extending from the central leg.

15. The cart of claim 9, wherein the lock includes a pair of opposing latch release buttons located in recesses of a body portion of the lock.

16. A cart comprising:
a body portion forming a receptacle;
a lid pivotable relative to the body portion; and
a lock assembly including:
a retractable belt fixed to the body portion; and
a lock configured to accept a hasp on the retractable belt.

17. The cart of claim 16, wherein the lock includes an actuator configured to move the lock between a locked position and an unlocked position and the lock includes a pair of opposing latch release buttons located in recesses of a body portion of the lock.

18. The cart of claim 17, wherein the actuator is gravity actuated to secure the hasp relative to the lock when the cart is in a first position and to release the hasp from the lock when the cart is in a non-upright orientation.

19. The cart of claim 17, wherein the actuator is in electrical communication with a controller configured to directed the actuator between a locked position and a released position in response to a receive a signal from a remote location.

20. The cart of claim 16, wherein the belt housing is attached to the body portion on a first side of the body portion and the lock is located on a second opposite side of the body portion and the lid includes a belt channel extending from opposing sides of the lid and aligned with the belt housing and the lock.
